(19) United States
(12) Patent Application Publication
(10) Pub. No.: US 2026/0334469 A1
(43) Pub. Date: Oct. 29, 2026

(54) Wood Remediator

(71) Applicant: ARXADA, LLC, Morristown, NJ (US)

(72) Inventors: Min Chen, Florham Park, NJ (US); Justin Duma, Morristown, NJ (US); Stephen Uphill, Blackley (GB); Andrew Hughes, Blackley (GB); Joseph Donabed, Modesto, CA (US)

(21) Appl. No.: 19/660,745

(22) Filed: Apr. 28, 2026

Related U.S. Application Data
(60) Provisional application No. 63/795,759, filed on Apr. 28, 2025.

(51) Int. Cl. A01N 37/16; A01N 25/02; A01P 3/00

(52) U.S. Cl. CPC A01N 37/16; A01N 25/02; A01P 3/00

(57) ABSTRACT

In general, the present disclosure is directed to methods of remediation of a wood product. The method includes contacting a surface of the wood product with a wood remediation solution. The wood remediation solution may include peracetic acid. The remediated wood product has an L value of 65 or more. Beneficially, the wood remediation solution provides a safe and halogen free alternative to current practices with a safer environmental fate.

### RELATED APPLICATION

The present application is based upon and claims priority to U.S. Provisional Patent Application Ser. No. 63/795,759, having a filing date of Apr. 28, 2025, which is incorporated herein by reference.

### BACKGROUND

Wood is a widely used natural material in construction, furniture, and infrastructure. For instance, hardwood is frequently used to construct furniture, and lower grade hardwood cuts generated during furniture construction have conventionally been used to make pallets. However, due to decreasing market demand for hardwood furniture, hardwood cuts for pallet construction have become increasingly scarce. As a result, pallet manufactures have turned to remediating and recycling old pallet materials. However, wood is highly susceptible to decomposition, fungal and bacterial growth, insect damage, and chemical degradation. Mold, mildew, and weathered lumber ends up being sold at discount due to unsightly appearance.

Conventional wood remediation techniques often involve harsh chemicals, high labor costs, and incomplete restoration, which can negatively affect structural integrity of the wood or introduce environmental issues. For instance, current industry practices use five percent bleach (sodium hypochlorite) solution, which has a potent smell and can breakdown into chloroform.

Accordingly, improved, halogen-free wood remediators and wood remediation methods would be useful.

### SUMMARY

In general, the present disclosure is directed to methods of remediation of a wood product. The method includes contacting a surface of the wood product with a wood remediation solution. The wood remediation solution may include peracetic acid. The remediated wood product has an L value of 65 or more. Beneficially, the wood remediation solution provides a safe and halogen free alternative to current practices with a safer environmental fate.

In one example aspect, the wood remediation solution may include from about 0.5% w/v to about 30% w/v peracetic acid.

In another example aspect, the wood remediation solution may include from about 1% w/v to about 25% w/v peracetic acid.

In another example aspect, the wood remediation solution may include from about 3% w/v to about 20% w/v peracetic acid.

In another example aspect, the wood remediation solution may include from about 5% w/v to about 15% w/v peracetic acid.

In another example aspect, the wood remediation solution may include a solvent.

In another example aspect, the method where the weight ratio of peracetic acid to solvent may be from about 1:1 to about 1:10.

In another example aspect, the weight ratio of peracetic acid to solvent may be from about 1:5 to about 1:10.

In one example aspect, the wood product may include one or more of a utility pole, a fence post, and a railway tie.

In another example aspect, the wood product may include one or more of pine, spruce, cedar, fir, hemlock, oak, maple, cherry, eucalyptus, poplar, beech, and aspen.

In one example aspect, the wood remediation solution may be contacted to the surface of the wood product by spraying, dipping, painting, brushing, pouring, rolling, curtain coating, soaking, partial vacuum, misting or a combination thereof.

In another example aspect, the wood remediation solution may be contacted to the surface of the wood product by spraying.

In one example aspect, mold on the wood product may be reduced by at least 30% after at least thirty (30) minutes of contact on the surface of the wood product.

In one example aspect, mold on the wood product may be reduced by at least 30% after at least 7 days of contact on the surface of the wood product.

In another example aspect, mold on the wood product is reduced by at least 30% after at least 14 days of contact on the surface of the wood product.

In another example aspect, mold on the wood product may be reduced by at least 40% after at least 14 days of contact on the surface of the wood product.

In another example aspect, mold on the wood product may be reduced by at least 50% after at least 14 days of contact on the surface of the wood product.

In one example aspect, the remediated wood product may have an L value of 75 or more.

In another aspect, the remediated wood product may have an L value of 85 or more.

These and other features and aspects, embodiments and advantages of the present invention will become better understood with reference to the following description and appended claims.

### BRIEF DESCRIPTION OF THE DRAWINGS

A full and enabling disclosure of the present disclosure is set forth more particularly in the remainder of the specification, including reference to the accompanying figures, in which:

FIG. 1 depicts a comparison between 1:1 dilution of PAA (left zone) in water, and 5% bleach (right zone) on predominantly mold/mildew-stained white oak. The middle zone represents no treatment.

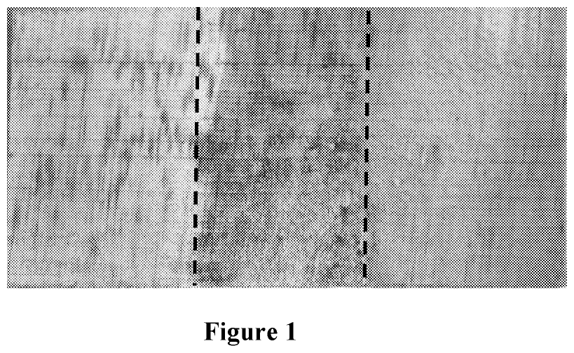

FIG. 2 depicts a discolored pallet board with mild fungal staining and significant weathering. PAA=peracetic acid formulation; % PAA activity.

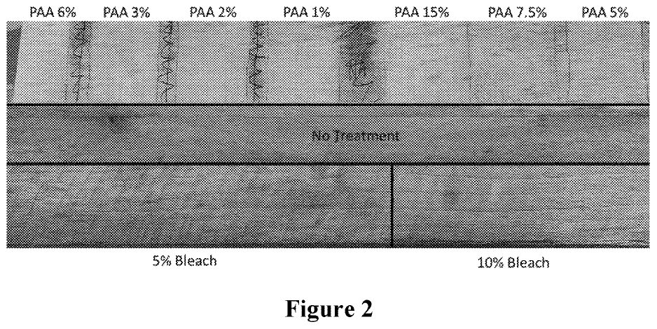

FIG. 3 depicts a discolored tannin-stained lumber bundle. PAA spray applied to right side at a 1:5 dilution. Photograph taken after 30 minutes of exposure.

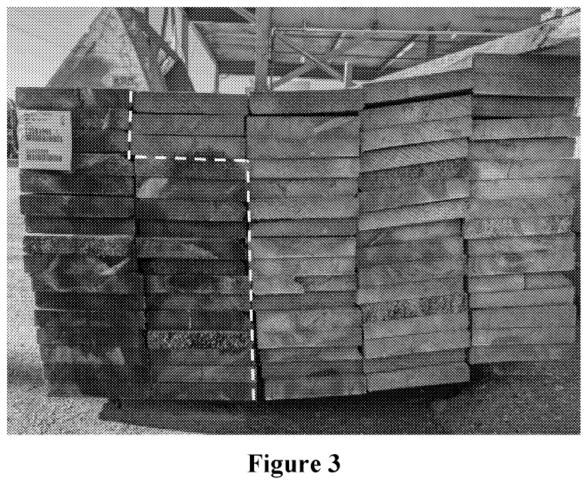

FIG. 4 depicts mold coverage of mixed hardwoods, treated and untreated, after 2 weeks of exposure to a mixed mold inoculum and high humidity.

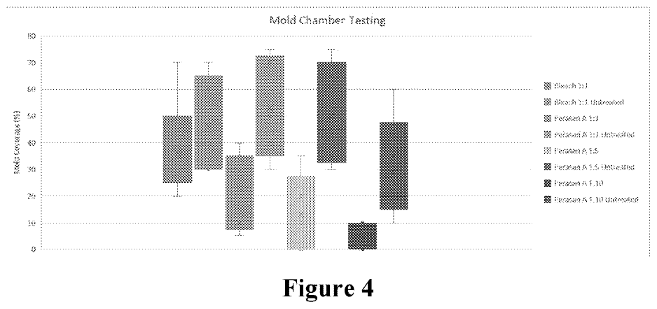

FIG. 5 depicts a mold recovery test of mixed hardwood samples.

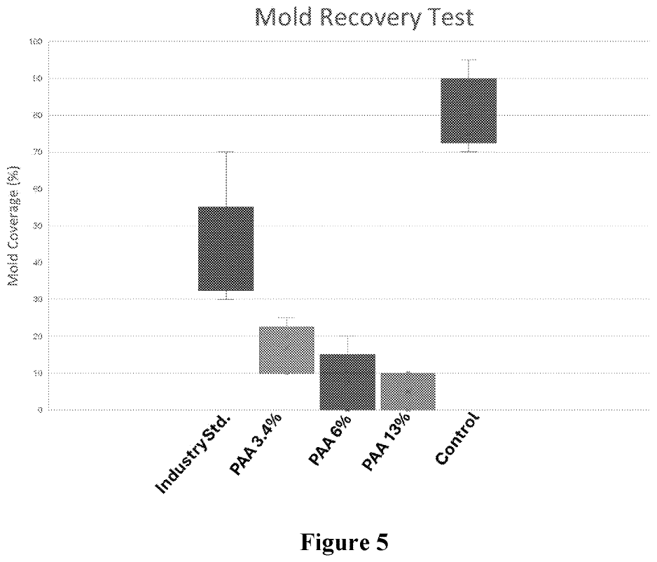

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to methods of remediation of a wood product. Current industry practices use sodium hypochlorite (e.g., bleach) or hydrogen peroxide as a wood remediator. Such products have drawbacks. For instance, sodium hypochlorite has a potent smell and can breakdown into chloroform. As another example, hydrogen peroxide has a short shelf-life. Surprisingly, disclosed herein is a wood remediation solution that includes, but is not limited to, an alternative halogen-free oxidizer having enhanced wood remediation performance. Beneficially, the wood remediation solution provides a safe and halogen free alternative to current practices with a safer environmental fate.

In one example embodiment, the wood remediation solution may include peracetic acid. Peracetic acid is food safe and breaks down into water and oxygen. As a strong oxidizing agent, peracetic acid may allow for removal of biological stains, mold/mildew/algae, and iron/tannin staining through oxidation. Generally, peracetic acid is also a delignification agent. Due to the oxidative nature of peracetic acid, it rapidly breaks down into non-toxic byproducts (e.g., acetic acid, oxygen, and water), making peracetic acid environmentally friendly. Surprisingly, as disclosed herein, peracetic acid also has enhanced wood remediation performance. In one example embodiment, the wood remediation solution may be environmentally friendly. In one example embodiment, the wood remediation solution may be halogen free.

In one example embodiment, peracetic acid may be present in the wood remediation solution in an amount from about 0.5% w/v to about 30% w/v, such as from about 1% w/v to about 25% w/v, such as from about 3% w/v to about 20% w/v, such as from about 5% w/v to about 15% w/v, or any range therebetween. For instance, in one example embodiment, peracetic acid may be present in the wood remediation solution in an amount from about 0.5% w/v to about 30% w/v. In another example embodiment, peracetic acid may be present in the wood remediation solution in an amount from about 1% w/v to about 25% w/v. In another example embodiment, peracetic acid may be present in the wood remediation solution in an amount from about 3% w/v to about 20% w/v. In another example embodiment, peracetic acid may be present in the wood remediation solution in an amount from about 5% w/v to about 15% w/v.

If desired, peracetic acid may be combined with another peracid. For instance, peracetic acid may be combined with an organic peracid or an inorganic peracid. The organic peracid may include, but is not limited to, performic acid, trifluoroperacetic acid, m-chloroperbenzoic acid, or mixtures thereof. The inorganic peracid may include, but is not limited to, peroxysulfuric acids, such as peroxymonosulfuric acid, peroxydisulfuric acid, or the like. In one example embodiment, for instance, the inorganic acid may include, but is not limited to, sodium perborate or sodium percarbonate.

If desired, in one example embodiment, peracetic acid may be combined with a carboxylic acid. In one example embodiment, for instance, the carboxylic acid may be a C₁ to C₁₄ carboxylic acid. For instance, the carboxylic acid may be a C₁ to C₄, such as a C₁ to C₂ carboxylic acid. In one example embodiment, the carboxylic acid may include, but is not limited to, formic acid, carbonic acid, and/or acetic acid. As used herein, a carboxylic acid includes carbonic acid in the context of the present disclosure. More particularly, carbonic acid is considered as one of the possible C₁ to C₂ carboxylic acids.

In one example embodiment, the wood remediation solution may include a solvent. For instance, solvent may be a solubilizer for peracetic acid in the wood remediation solution. The solvent may include, but is not limited to, water, an alcohol, or a combination thereof. In one example embodiment, the solvent may be water. In another example embodiment, the solvent may be an alcohol. For instance, an alcoholic solvent may include, but is not limited to, ethanol, propanol, isopropanol, n-butanol, benzyl alcohol, ethylene glycol, propylene glycol, butylene glycol, or mixtures thereof and the like.

In some example embodiments, the solvent may be present in an amount from about 20% to about 95% by weight, such as from about 30% to about 85% by weight, such as from about 40% to about 75% by weight, or any range therebetween. In one example embodiment, the solvent may be present in an amount from about 20% to about 95% by weight. In another example embodiment, the solvent may be present in an amount from about 30% to about 85% by weight. In another example embodiment, the solvent may be present in an amount from about 40% to about 75% by weight.

In general, the amount of solvent present in the wood remediation solution may be adjusted in order to select the level of peracetic acid in the wood remediation solution. In one example embodiment, for instance, the ratio of peracetic acid to solvent in the wood remediation solution may be from about 10:1 to about 1:10, such as from about 5:1 to about 1:5, such as from about 1:1 to about 1:10, such as from about 1:5 to about 1:10, or any range therebetween. In one example embodiment, the ratio of peracetic acid to solvent in the wood remediation solution may be from about 10:1 to about 1:10. In another example embodiment, the ratio of peracetic acid to solvent in the wood remediation solution may be from about 5:1 to about 1:5. In another example embodiment, the ratio of peracetic acid to solvent in the wood remediation solution may be from about 1:1 to about 1:10. In another example embodiment, the ratio of peracetic acid to solvent in the wood remediation solution may be from about 1:5 to about 1:10.

Methods disclosed herein may include contacting a surface of a wood product with peracetic acid as an effective wood remediator. As used herein, a “wood remediator” refers to a product and/or process designed to treat and restore wood that has been damaged or compromised by environmental factors, pests, or contaminants. Advantageously, peracetic acid may be utilized to treat and restore a wood product to a stable, durable condition, ensuring continued functionality and extending useful life. The wood product may include, but is not limited to, softwoods (e.g., refractory and non-refractory) and hardwoods. For instance, in one example embodiment, the wood product may be one or more of a utility pole, a fence post, and a railway tie. In another example embodiment, the wood product may be a product formed from one or more of pine, spruce, cedar, fir, hemlock, oak, maple, cherry, eucalyptus, poplar, beech, and aspen. In one example embodiment, the wood product may be a product formed from oak. In another example embodiment, the wood product may be a product formed from pine. In another example embodiment, the wood product may be a product formed from cedar.

In one example embodiment, the wood remediation solution may be applied to the wood product using conventional application methods known in the art for liquid application to wood products. For instance, the wood remediation solution may be applied to the surface of the wood product by spraying, dipping, painting, brushing, pouring, rolling, curtain coating, hot or cold soaking, partial vacuum, misting, or a combination thereof. In one example embodiment, the wood remediation solution may be applied to the surface of the wood product by spraying. In another example embodiment, the wood remediation solution may be applied to the surface of the wood product by coating. In another example embodiment, the wood remediation solution may be applied to the surface of the wood product by partial vacuum. In another example embodiment, the wood remediation solution may be applied to the surface of the wood product by misting.

In general, the wood remediation solution disclosed herein, including peracetic acid, may contact the surface of a wood product for any amount time effective to restore the stability and functionality of the wood product. In one example embodiment, mold on the wood product may be reduced by at least 30% after at least thirty (30) minutes of contact on the surface of the wood product, such as after at least sixty (60) minutes, such as at least one-hundred twenty (120) minutes, or such as at least three-hundred sixty (360) minutes. For instance, depending on the wood product, peracetic acid may contact the surface of the wood product for from about one (1) day to about twenty-one (21) days, such as from about three (3) days to about fourteen (14) days, such as from about five (5) days to about ten (10) days, or any range therebetween. In one example embodiment, peracetic acid may contact the surface of the wood product for from about one (1) day to about twenty-one (21) days. In another example embodiment, peracetic acid may contact the surface of the wood product for from about three (3) days to about fourteen (14) days. In another example embodiment, peracetic acid may contact the surface of the wood product for from about five (5) days to about ten (10) days.

In some example embodiments, following contacting a wood product with peracetic acid, the color difference and/or color stability of the treated wood product may be evaluated. For instance, in one example embodiment, following contacting a wood product with peracetic acid, the lightness (L) of the color may be evaluated (e.g., L=100 for white and L=0 for black). In some example embodiments, following contacting a wood product with peracetic acid, the wood product may have an absolute lightness (L) value of 65 or more, as determined by ASTM E1347, Standard Test Method for Color and Color-Difference Measurement by Tristimulus (Filter) Colorimetry. As used herein, “lightness” refers to an increasing the reflectance and/or whiteness of fibers of the wood product as a result of remediation with peracetic acid and, notably, in the absence of bleach. In one example embodiment, following contacting a wood product with peracetic acid, the wood product may have an L value of 75 or more, as determined by ASTM E1347, Standard Test Method for Color and Color-Difference Measurement by Tristimulus (Filter) Colorimetry. In another example embodiment, following contacting a wood product with peracetic acid, the wood product may have an L value of 85 or more, as determined by ASTM E1347, Standard Test Method for Color and Color-Difference Measurement by Tristimulus (Filter) Colorimetry.

In one example embodiment, following contacting a wood product with peracetic acid, the wood product may have an increase of at least 10% in lightness compared to the initial, untreated state of the wood product, as determined by ASTM E1347, Standard Test Method for Color and Color-Difference Measurement by Tristimulus (Filter) Colorimetry. For instance, following contacting a wood product with peracetic acid, the wood product may have an increase of at least 20% in lightness compared to the initial, untreated state of the wood product, such as at least 30% in lightness compared to the initial, untreated state of the wood product, or such as at least 40% in lightness compared to the initial, untreated state of the wood product, as determined by ASTM E1347, Standard Test Method for Color and Color-Difference Measurement by Tristimulus (Filter) Colorimetry.

In some example embodiments, peracetic acid may be effective for removing and/or reducing biological stains, mold, mildew, algae, fungi, and/or bacteria from the surface of a wood product. Exemplary microorganisms may include one or more species from one or both of the following groups:
Fungi: Acremonium such as Acremonium strictum, Alternaria such as Alternaria tenuis or Alternaria alternata, Aspergillus such as Aspergillus niger or Aspergillus brasiliensis, Aureobasidium such as Aureobasidium pullulans, Candida such as Candida albicans, Chaetomium such as Chaetomium globosum, Coniophora such as Coniophora puteana, Fusarium such as Fusarium solani, Geotrichum such as Geotrichum candidum, Lentinus such as Lentinus tigrinus, Penicillium such as Penicillium citrinum, Penicillium glaucum, Penicillium funiculosum or Penicillium pinophilum, Rhodotorula such as Rhodotorula rubra or Rhodotorula mucilaginosa, Stachybotrys such as Stachybotrys chartarum, Trametes such as Trametes versicolor, Trichoderma such as Trichoderma virens, Wolfiporia such as Wolfiporia cocos; and
Bacteria: Alcaligenes such as Alcaligenes faecalis, Acinetobacter such as Acinetobacter calcoaceticus, Bacillus such as Bacillus subtilis, Citrobacter such as Citrobacter freundii, Corynebacterium such as Corynebacterium ammoniagenes, Enterobacter such as Enterobacter aerogenes or Enterobacter cloacae, Enterococcus such as Enterococcus hirae, Escherichia such as Escherichia coli, Proteus such as Proteus hauseri, Pseudomonas such as Pseudomonas aeruginosa, Pseudomonas fluorescens or Pseudomonas stutzeri, Salmonella such as Salmonella enterica, Staphylococcus such as Staphylococcus aureus.

In one example embodiment, for instance, mold on the surface of the wood product may be reduced by at least 30% after at least 7 days of contact on the surface of the wood product. For instance, in one example embodiment, mold on the surface of the wood product may be reduced by at least 30% after at least 10 days of contact on the surface of the wood product. In another example embodiment, mold on the surface of the wood product may be reduced by at least 30% after at least 14 days of contact on the surface of the wood product. In another example embodiment, mold on the surface of the wood product may be reduced by at least 40% after at least 14 days of contact on the surface of the wood product. In another example embodiment, mold on the surface of the wood product may be reduced by at least 50% after at least 14 days of contact on the surface of the wood product. In another example embodiment, mold on the surface of the wood product may be reduced by at least 60% after at least 14 days of contact on the surface of the wood product.

Within this specification, embodiments have been described in a way that enables a clear and concise specification to be written, but it is intended and will be appreciated that embodiments may be variously combined or separated without departing from the disclosure. For example, it will be appreciated that all preferred features described herein are applicable to all aspects of the disclosure described herein.

In some example embodiments, the disclosure herein can be construed as excluding any element or process step that does not materially affect the basic and novel characteristics of the composition or process. Additionally, in some embodiments, the disclosure can be construed as excluding any element or process step not specified herein.

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values therebetween. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material. It will be understood that, in certain example embodiments, the compositions described herein may be substantially free of any substance not specifically recited.

As used in this application and in the claims, the singular forms “a,” “an,” and “the” include the plural forms unless the context clearly dictates otherwise. Additionally, the term “includes” means “comprises.” The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

Unless otherwise indicated, all numbers expressing quantities of ingredients, properties such as molecular weight, percentages, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” means by weight as a percentage of the total weight or relative to another component in the composition.

Although the disclosure is illustrated and described herein with reference to specific embodiments, the disclosure is not intended to be limited to the details shown. Rather, various modifications may be made in the details within the scope and range of equivalents of the claims and without departing from the disclosure.

### EXAMPLES

### Example 1

### Surface Brightness of Stained Wood Products

Three 25 inch mold/mildew stained and weathered white oak and southern yellow pine boards were taken and divided into five 4 inch sections using painters tape. Surfaces were applied with 25 mL of solution using a brush and sat for 24 hours at ambient temperature. Surfaces were cleaned of large particles of dirt and biomass using a medium bristle brush going with the grain of the wood. Samples were measured for luminance or lightness using a handheld spectrophotometer, TR 500 Lovibond, using the D65 brightness setting. This unit was calibrated to the white and black standards before testing were black is zero (0) and white is one-hundred (100), as determined by ASTM E1347, Standard Test Method for Color and Color-Difference Measurement by Tristimulus (Filter) Colorimetry. The following data represents the mean of three board matched samples with five data points. The control represents the stained wood without any application.

TABLE 1
Surface brightness of stained white oak post-application

| Application | Mean Lightness |
|---|---|
| Control | 29.7 |
| Industry Standard* | 48.3 |
| 3.4% Peracetic acid | 70.6 |
| 6% Peracetic acid | 72.1 |
| 13% Peracetic acid | 72.5 |

*5% bleach

TABLE 2
Surface brightness of stained southern yellow pine post-application

| Application | Mean Lightness |
|---|---|
| Control | 40.7 |
| Industry Standard* | 53.7 |
| 3.4% Peracetic acid | 66.8 |
| 6% Peracetic acid | 70.0 |
| 13% Peracetic acid | 70.6 |

*5% bleach
**Note
spectrophotometer was calibrated so that black is 0 and white is 100.

### Example 2

### Mold Recovery Test of Wood Products

Four inch mixed hardwood samples were inoculated with a mixture of four species of wood staining fungi, Trichoderma virens, Aureobasidium pullulans, Penicillium citrinum, Aspergillus niger. Samples were placed in container with 1 cm of water and a plastic sample holder. Samples were incubated at 26 °C and 80% relative humidity until the wood product had at least 70% mold coverage. Inoculated samples were sprayed with 50 g of remediation solution. After 24 hours samples were placed back in the incubator to assess recovery of mold post-remediation. Samples were assessed after 3 weeks of incubation for % mold coverage. Control consists of wood sprayed with distilled water. Data represents the mean of five replicates of board matched samples.

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the disclosure so further described in such appended claims.

What is claimed:

1. A method of remediation of a wood product, the method comprising:
contacting a surface of the wood product with a wood remediation solution comprising peracetic acid,
wherein the remediated wood product has a lightness (L) value of 65 or more.

2. The method of claim 1, wherein the wood remediation solution comprises from about 0.5% w/v to about 30% w/v peracetic acid.

3. The method of claim 1, wherein the wood remediation solution comprises from about 1% w/v to about 25% w/v peracetic acid.

4. The method of claim 1, wherein the wood remediation solution comprises from about 3% w/v to about 20% w/v peracetic acid.

5. The method of claim 1, wherein the wood remediation solution comprises from about 5% w/v to about 15% w/v peracetic acid.

6. The method of claim 1, the wood remediation solution further comprising a solvent.

7. The method of claim 7, wherein the ratio of peracetic acid to solvent of from about 10:1 to about 1:10.

8. The method of claim 7, wherein the ratio of peracetic acid to solvent of from about 1:1 to about 1:10.

9. The method of claim 7, wherein the ratio of peracetic acid to solvent of from about 1:5 to about 1:10.

10. The method of claim 1, wherein the wood product comprises one or more of a utility pole, a fence post, and a railway tie.

11. The method of claim 1, wherein the wood product comprises a product formed from one or more of pine, spruce, cedar, fir, hemlock, oak, maple, cherry, eucalyptus, poplar, beech, and aspen.

12. The method of claim 1, wherein the wood remediation solution is contacted to the surface of the wood product by spraying, dipping, painting, brushing, pouring, rolling, curtain coating, soaking, partial vacuum, misting or a combination thereof.

13. The method of claim 12, wherein the wood remediation solution is contacted to the surface of the wood product by spraying.

14. The method of claim 1, wherein mold on the wood product may be reduced by at least 30% after at least thirty (30) minutes of contact on the surface of the wood product.

15. The method of claim 1, wherein mold on the wood product is reduced by at least 30% after at least 7 days of contact on the surface of the wood product.

16. The method of claim 14, wherein mold on the wood product is reduced by at least 30% after at least 14 days of contact on the surface of the wood product.

17. The method of claim 16, wherein mold on the wood product is reduced by at least 40% after at least 14 days of contact on the surface of the wood product.

18. The method of claim 16, wherein mold on the wood product is reduced by at least 50% after at least 14 days of contact on the surface of the wood product.

19. The method of claim 1, wherein the remediated wood product has an L value of 75 or more.

20. The method of claim 1, wherein the remediated wood product has an L value of 85 or more.
